(19) United States
(12) Patent Application Publication
(10) Pub. No.: US 2015/0142694 A1
(43) Pub. Date: May 21, 2015

(54) BUSINESS PROCESS REALIZATION SYSTEM, OPERATION METHOD AND NON-TRANSITORY COMPUTER READABLE STORAGE MEDIUM THEREOF

(71) Applicant: Institute for Information Industry, Taipei (TW)

(72) Inventors: Sheng-Po Tseng, Hsinchu City (TW); Vincent Hua, New Taipei City (TW); Ko-Yang Wang, Taipei City (TW); Chi-Hung Tsai, Taipei City (TW)

(73) Assignee: Institute for Information Industry, Taipei (TW)

(21) Appl. No.: 14/100,093

(22) Filed: Dec. 9, 2013

(30) Foreign Application Priority Data
Nov. 20, 2013 (TW) 102142285

(51) Int. Cl. G06Q 10/06

(52) U.S. Cl. CPC G06Q 10/067
USPC 705/348

(57) ABSTRACT

A business process realization system, an operation method and a non-transitory computer readable storage medium thereof are provided. The business process realization system includes a user interface module, a storage unit, an access module, and an identification module. The user interface is configured to receive first input commands corresponding to a business process. The access module is configured to retrieve search results form information technology (IT) resources according to the first input commands and a process architecture and to analyze the search results so as to retrieve first corresponding information technology resources. The identification module is configured to link the first corresponding information technology resources with the first input commands so as to correspond the first corresponding information technology resources to the process architecture and to determine that at least one difference item is not linked with the first corresponding information technology resources.

### RELATED APPLICATIONS

This application claims priority to Taiwan Application Serial Number 102142285, filed Nov. 20, 2013, which is herein incorporated by reference.

### BACKGROUND

1. Technical Field

The present invention relates to a business process realization system, an operation method and a non-transitory computer readable storage medium thereof. More particularly, the present invention relates to a business process realization system, an operation method and a non-transitory computer readable storage medium thereof for modifying and storing information technology (IT) resources.

2. Description of Related Art

An existing design method for meeting the requirements in compliance with a service-oriented architecture is based on a layered architecture to present a business process level and an information technology (IT) level individually. The business process level is a business process architecture, and the information technology level is an information technology architecture.

When the business process level has activities occurring, the information technology level generates service resources correspondingly. However, when the activities of the business process or the service resources of the information technology are adjusted, the corresponding relationships between the activities of the business process and the service resources will not be reserved. In other words, when the activities of the business process and the service resources of the information technology need to be adjusted, a user cannot directly find the corresponding relationships between the activities of the business process level and the service resources of the information technology, and portions of the business process level and the service resources of the information technology which will be subsequently affected after adjustment.

Accordingly, the user often needs to thoroughly check the entire computer system, thus not only wasting checking time but also resulting in the increases of manpower and cost.

### SUMMARY

An aspect of the present invention is to provide a business process realization system. According to an embodiment of the present invention, the business process realization system includes a storage unit, a user interface module, an access module, and an identification module. The storage unit is configured to store a plurality of information technology (IT) resources. The user interface module is configured to receive a plurality of first input commands corresponding to a business process so that the business process is expanded into a process architecture according to the first input commands. The access module includes a storage searching module and a storage analysis module. The storage searching module is configured to organize a plurality of search conditions according to the first input commands and the process architecture and to retrieve a plurality of search results from the information technology resources. The storage analysis module is configured to analyze the search results and to retrieve a plurality of first corresponding information technology resources corresponding to the process architecture. The identification module includes a resource linking module and a resource analysis module. The resource linking module is configured to link the first corresponding information technology resources with the first input commands so as to correspond the first corresponding information technology resources to the process architecture. The resource analysis module is configured to analyze the process architecture and to determine that at least one difference item is not linked with the first corresponding information technology resources.

According to one embodiment of the present invention, wherein the identification module further includes a resource adding module. When the user interface module receives a second input command corresponding to the at least one different item, the resource adding module is configured to add the at least difference item to the first corresponding information technology resources according to the second command so as to turn the first corresponding information technology resources into the second corresponding information technology resources.

According to one embodiment of the present invention, wherein the resource linking module further links the second corresponding information technology resources with the first input commands so as to correspond the second corresponding information technology resources to the process architecture.

According to one embodiment of the present invention, wherein the access module further includes a storage adding module. The storage adding module is configured to store the second corresponding information technology resources into the storage unit.

According to one embodiment of the present invention, wherein the access module further includes a storage adding module. The storage adding module is configured to store relationships between the process architecture and the second corresponding information technology resources into the storage unit.

According to one embodiment of the present invention, the business process realization system further includes an expansion module, wherein the expansion module is configured to expand the business process into the process architecture according to the first input commands and to enable a display to display the process architecture.

According to one embodiment of the present invention, wherein the resource linking module further enables a display to display corresponding relationships between the process architecture and the first corresponding information technology resources.

According to one embodiment of the present invention, wherein the process architecture includes a tree architecture diagram or a fish-bone diagram.

Another aspect of the present invention is to provide an operation method of a business process realization system. According to an embodiment of the present invention, the operation method is for use in a business process realization system. The business process realization system includes a storage unit, a user interface, an access module, and an identification module. The access module includes a storage searching module and a storage analysis module. The identification module includes a resource linking module and a resource analysis module. The operation method includes: receiving a plurality of first input commands corresponding to a business process by the user interface and expanding the business process into a process architecture according to the first input commands; enabling the storage searching module to organize a plurality of search conditions according to the first input commands and the process architecture and retrieving a plurality of search results from a plurality of information technology resources; analyzing the search results by the storage analysis module and retrieving a plurality of first corresponding information technology resources corresponding to the process architecture; linking the first corresponding information technology resources with the first input commands by the resource linking module so as to correspond the first corresponding information technology resources to the process architecture; and analyzing the process architecture by the resource analysis module and determining that at least one difference item is not linked with the first corresponding information technology resources.

According to one embodiment of the present invention, wherein the identification module further includes a resource adding module. The operation method further includes: receiving a second input command corresponding to the at least one difference item by the user interface; enabling the resource adding module to add the at least difference item to the first corresponding information technology resources according to the second command; and enabling the first corresponding information technology resources to be turned into the second corresponding information technology resources by the resource adding module.

According to one embodiment of the present invention, the operation method further includes: linking the second corresponding information technology resources with the first input commands by the resource linking module so as to correspond the second corresponding information technology resources to the process architecture.

According to one embodiment of the present invention, wherein the access module further includes a storage adding module. The operation method further includes: storing the second corresponding information technology resources into the storage unit by the storage adding module.

According to one embodiment of the present invention, wherein the business process realization system further includes an expansion module. The operation method further includes: expanding the business process into the process architecture by the expansion module according to the first input commands and enabling a display to display the process architecture.

According to one embodiment of the present invention, the operation method further includes: enabling a display to display corresponding relationships between the process architecture and the first corresponding information technology resources.

According to one embodiment of the present invention, wherein the access module further includes a storage adding module. The operation method further includes: storing relationships between the process architecture and the second corresponding information technology resources into the storage unit by the storage adding module.

Yet another aspect of the present invention is to provide a non-transitory computer readable storage medium. According to an embodiment of the present invention, the non-transitory computer readable storage medium has stored with a computer program executable to perform an operation method, in which the operation method is used in a business process realization system. The operation method includes: receiving a plurality of first input commands corresponding to a business process by the user interface and expanding the business process into a process architecture according to the first input commands; enabling the storage searching module to organize a plurality of search conditions according to the first input commands and the process architecture and retrieving a plurality of search results from a plurality of information technology resources; analyzing the search results by the storage analysis module and retrieving a plurality of first corresponding information technology resources corresponding to the process architecture; linking the first corresponding information technology resources with the first input commands by the resource linking module so as to correspond the first corresponding information technology resources to the process architecture; and analyzing the process architecture by the resource analysis module and determining that at least one difference item is not linked with the first corresponding information technology resources.

In summary, by applying one of the above embodiments, the activities of the business process architecture are directly corresponding to the service resources of the information technology, and the business process architecture is linked to the information technology architecture. Accordingly, the implementations of the information technology resources will be no longer useless. When the business process realization system receives similar commands, the business process realization system can quickly retrieve the corresponding information technology resources from the storage unit. Furthermore, the business process realization system further stores the corresponding relationships between the business process and the information technology resources. When one of the business process and the information technology resources needs to be adjusted, a user can still clearly understand the subsequent effects after adjustment. There is no need to check the entire system, and thus the time of checking the system, manpower and cost expenses can be reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a business process realization system according to an embodiment of the present invention;

FIG. 2A is a flowchart diagram of an operation method of a business process realization system according to an embodiment of the present invention; and

FIG. 2B to FIG. 2E are schematic diagrams showing an operation interface of a business process realization system according to an embodiment of the present invention.

### DETAILED DESCRIPTION

In the following descriptions, the present invention will be explained with reference to embodiments thereof. However, these embodiments are not intended to limit the present invention to any specific environment, applications or particular implementations described in these embodiments. Therefore, descriptions of these embodiments are only for the purpose of illustration rather than to limit the present invention. It should be appreciated that, in the following embodiments and the attached drawings, elements not directly related to the present invention are omitted from depiction; and dimensional relationships among individual elements in the attached drawings are illustrated only for ease of understanding, but not to limit the actual scale.

The phrases “first”, “second” and the like used herein are neither intended to specifically designate a sequence or order nor intended to limit the disclosure, and are only used to distinguish one element from another.

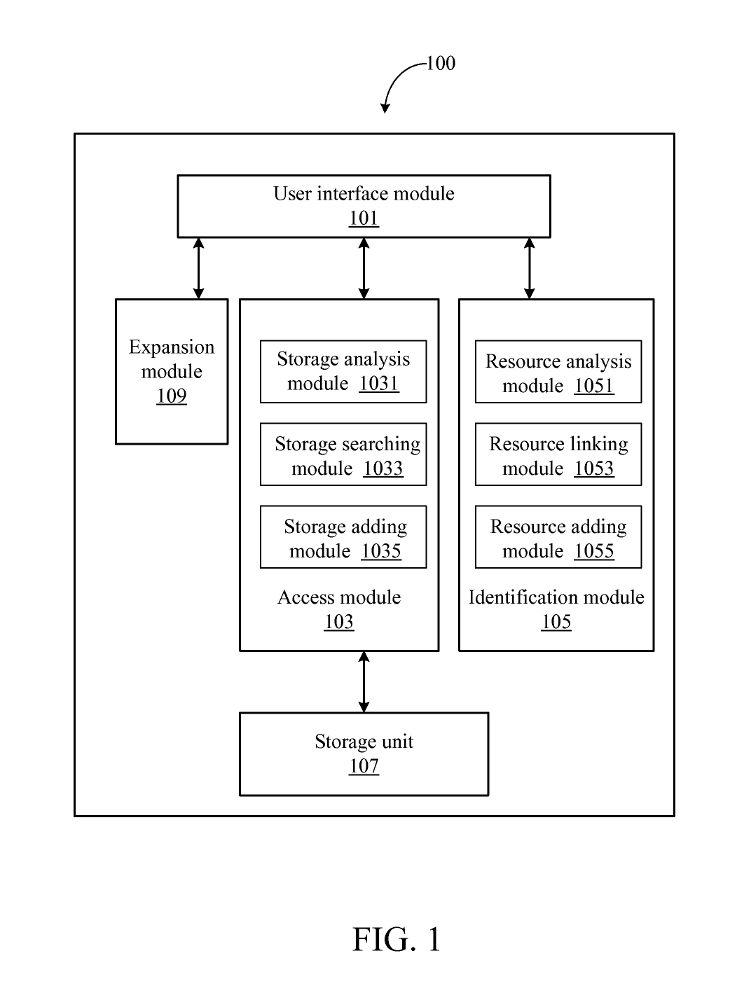

An embodiment of the present invention is a business process realization system 100, and its schematic view is depicted in FIG. 1. As shown in FIG. 1, the business process realization system 100 includes a user interface module 101, an access module 103, an identification module 105, a storage unit 107 and an expansion module 109.

In this embodiment, a plurality of information technology (IT) resources are stored in the storage unit 107. For example, the aforementioned information technology resources may be information technology services, information technology implementations, or information technology architectures, and the information technology resources are platform-specific. The storage unit 107 may be a database, a flash memory, a floppy disk, a hard disk, a compact disk (CD), a mobile disk, or another storage media with the same function and well known to those skilled in the art.

Additionally, the user interface module 101 is configured to receive a plurality of first input commands. The aforementioned first input commands correspond to a business process (not shown in FIG. 1). For example, the first input commands correspond to a business process, and the business process is platform-independent.

In this embodiment, the expansion module 109 expands the business process into a process architecture according to the first input commands, and enables a display (not shown in FIG. 1) to display the process architecture, in which the input commands correspond to a business process. In other words, the expansion module 109 expands the business process into the aforementioned process architecture according to the first input commands corresponding to the business process.

As shown in FIG. 1, the access module 103 includes a storage analysis module 1031 and a storage searching module 1033. The storage searching module 1033 is configured to organize a plurality of search conditions according to the first input commands and the process architecture, and retrieves a plurality of search results from the information technology resources stored in the storage unit 107. The storage analysis module 1031 is configured to analyze the search results, and retrieves a plurality of first corresponding information technology resources corresponding to the process architecture.

In this embodiment, the identification module 105 includes a resource analysis module 1051, a resource linking module 1053 and a resource adding module 1055. The link module 1053 is configured to link the first corresponding information technology resources with the aforementioned first input commands so as to correspond the first corresponding information technology resources to activity nodes of the aforementioned process architecture, and to enable a display to display the corresponding relationships between the aforementioned process architecture and the first corresponding information technology resources. The resource analysis module 1051 is configured to analyze the aforementioned process architecture and to determine that at least one difference item is not linked with the first corresponding information technology resources.

Furthermore, the user interface module 101 is further configured to receive a second input command, in which the second input command corresponds to the aforementioned at least one difference item. The resource adding module 1055 adds the at least one difference item to the first corresponding information technology resources according to the second commands so as to turn the first corresponding information technology resources into the second corresponding information technology resources.

In this embodiment, the resource linking module 1053 links the second corresponding information technology resource with the aforementioned first input commands so as to correspond the second corresponding information technology resources to activity nodes of the aforementioned process architecture.

As shown in FIG. 1, the access module 103 further includes a storage adding module 1035. The storage adding module 1035 is configured to store the updated second corresponding information technology resources to the storage unit 107. Accordingly, the storage adding module 1035 further stores the relationships between the process architecture and the second corresponding information technology resources to the storage unit. As a result, when the user interface module 101 receives the aforementioned first input commands, the access module 103 retrieves the stored second corresponding information technology resources from the storage unit 107.

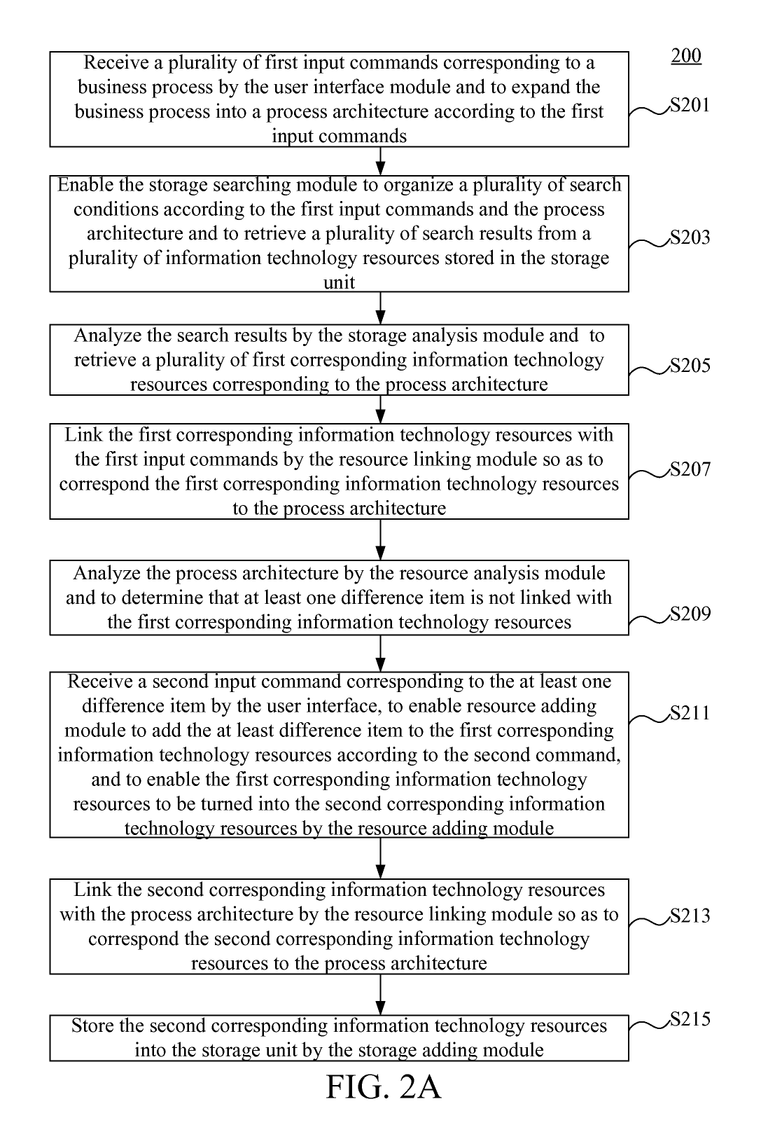

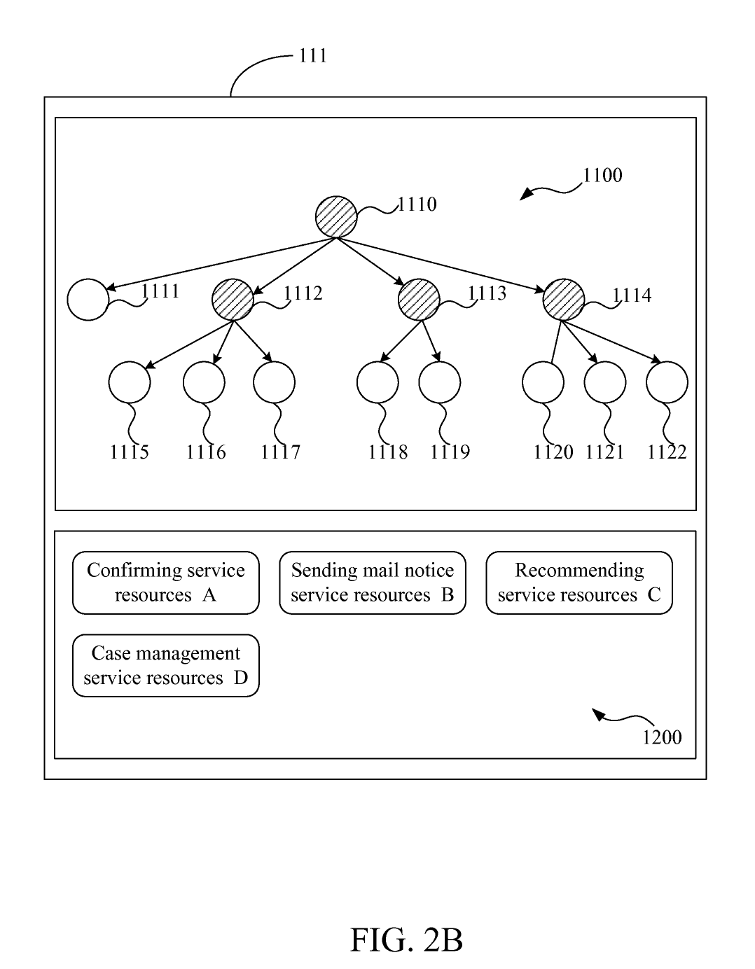

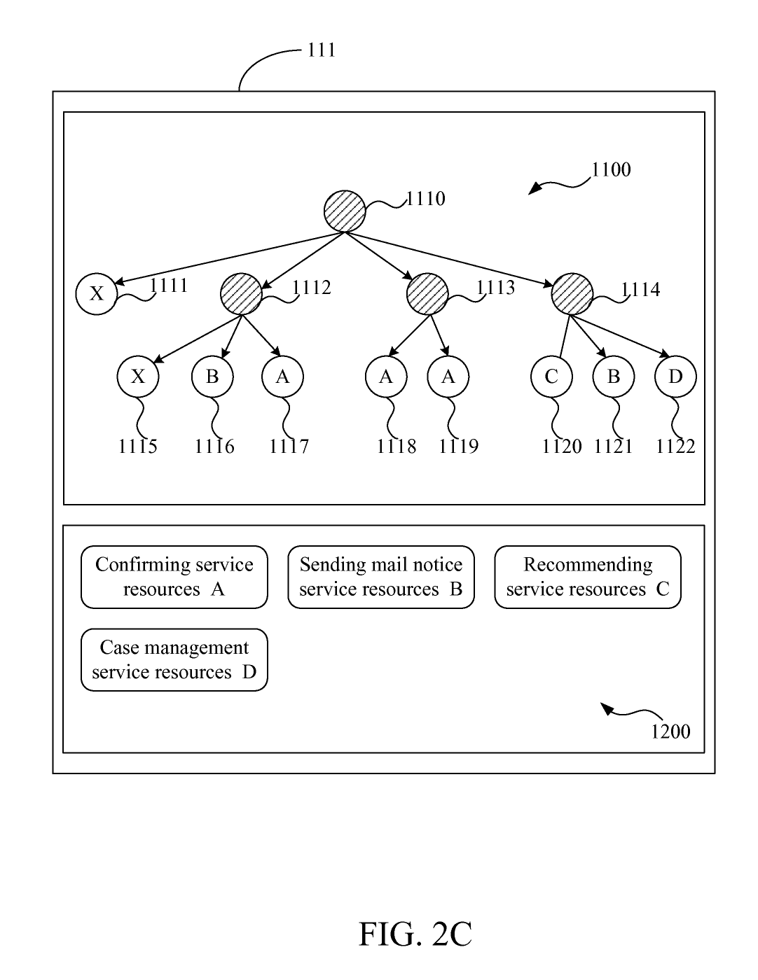

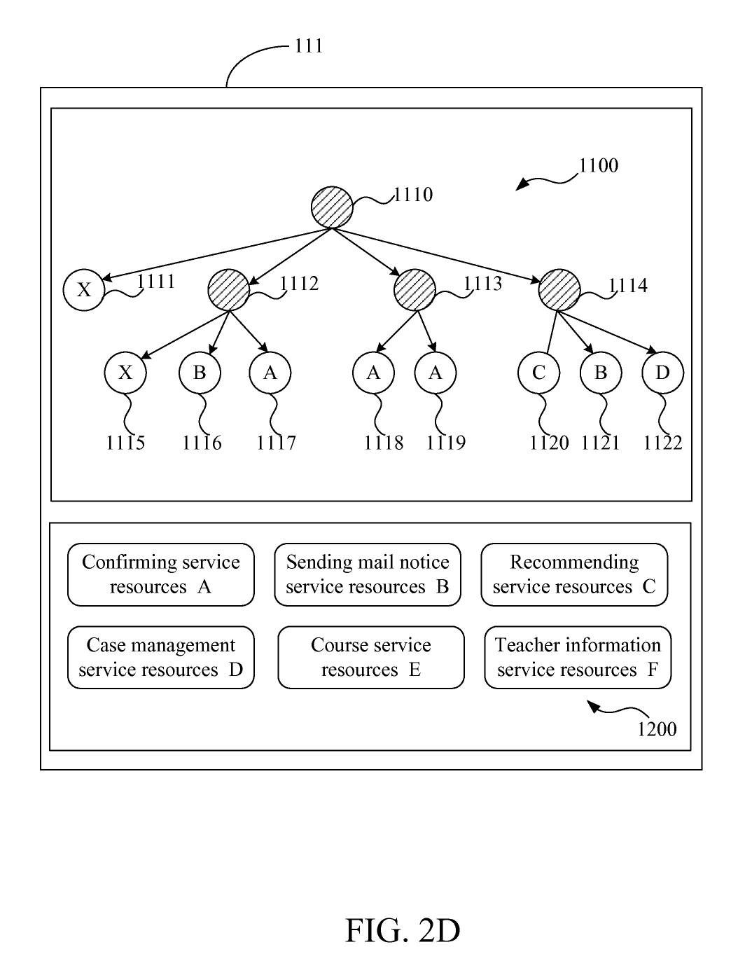

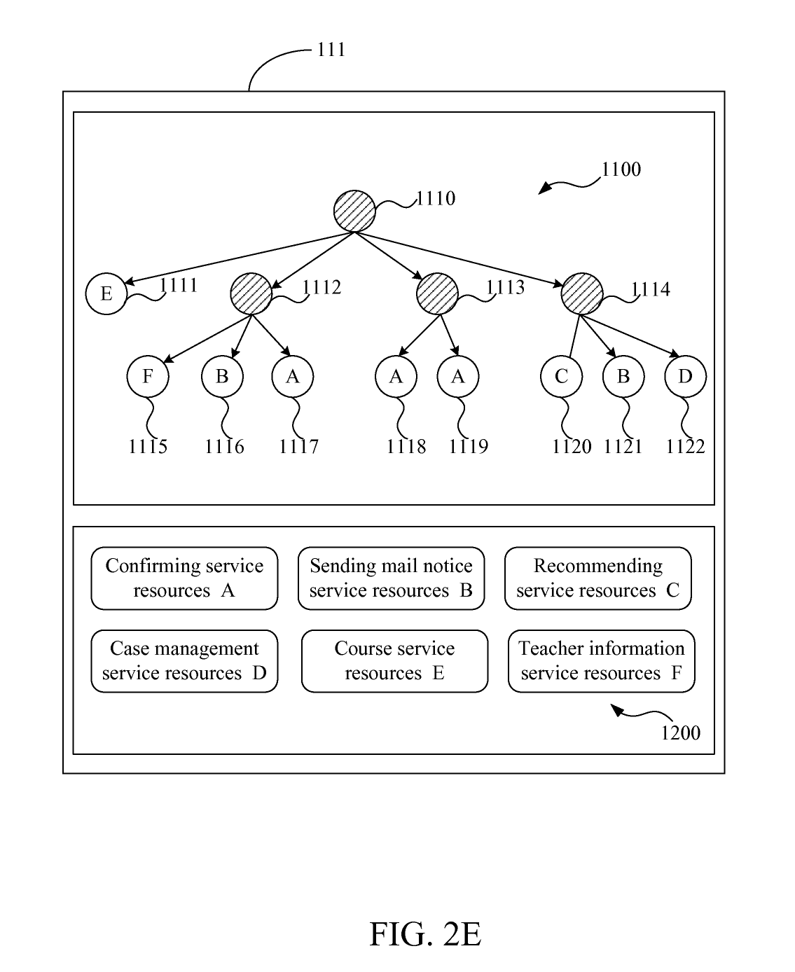

Referring to FIG. 2A, FIG. 2A is a flowchart diagram 200 of an operation method of a business process realization system according to an embodiment of the present invention.

Firstly, step S201 is performed to receive a plurality of first input commands corresponding to a business process by the user interface module 101 and expand the business process into a process architecture according to the first input commands.

Referring to FIG. 2B and FIG. 2A, FIG. 2B is a schematic view of an operation interface of a business process realization system according to an embodiment of the present invention.

For example, the business process realization system 100 further includes a display 111, and the display 111 is connected to the business process realization system 100 in a wired or wireless way. The display 111 is configured as an operating interface to display the business process realization system 100. When the user interface module 101 receives the first input commands, which are “course on boarding process” and activities included therein, respectively, the expansion module 109 expands “course on boarding process” and activities included therein into a process architecture 1100 according to the aforementioned first input commands, and enables the display 111 to display the process architecture 1100. In other words, the first commands correspond to “course on boarding process” and activities included therein.

In this embodiment, the process architecture 1100 includes a plurality of nodes 1110 to 1122, in which node 1110 is “course on boarding process” and is the main process presented in the process architecture. Nodes 1111 to 1114 are “filling in course commencement information,” “searching teacher information,” “predetermining time and location,” and “issuing,” respectively, and nodes 1111 to 1114 are sub-processes presented in the process architecture. It should be appreciated that the aforementioned numbers of nodes are merely used to explain an implementation of the present invention, and the present invention is not limited to the aforementioned numbers of nodes.

Furthermore, nodes 1115 to 1117 are “selecting teachers,” “informing teachers,” and “confirming and filling in teacher information,” respectively. Nodes 1118 to 1119 are “confirming and filling in time information” and “confirming and filling in location information,” respectively. Nodes 1120 to 1122 are “recommending members,” “sending invitations,” and “issuing courses,” respectively.

In other words, the expansion module 109 expands the process architecture 1110 and enables the display 111 to display the process architecture 1110, in which the process architecture 1110 is corresponding to the process architecture expanded from the first input commands. It should be appreciate that the first input commands can include process descriptions, activities and business objects and so on, but the present invention is not limited thereto.

Furthermore, the process architecture 1100 considers each of the main process, the sub-process and the activities as a node, and the expansion relationship of the process architecture 1100 is illustrated by connecting the nodes, but the present invention is not limited to any form of the process architecture 1100. For example, the process architecture may be a tree architecture diagram or a fish-bone diagram.

Next, step S203 is performed to enable the storage searching module 1033 to organize a plurality of search conditions according to the first input commands and the process architecture and to retrieve a plurality of search results from a plurality of information technology resources stored in the storage unit 107.

For example, as shown in FIG. 2B, the storage searching module 1033 is based on the first input commands including process descriptions, activities and business objects, or the aforementioned process architecture as the search conditions, and retrieves the existing information technology resources stored in the storage unit 107 that meet the requirements of the activities in the process architecture 1100.

Then, step S205 is performed to analyze the search results by the storage analysis module 1031 and to retrieve a plurality of first corresponding information technology resources corresponding to the process architecture.

For example, as shown in FIG. 2B, the first corresponding information technology resources retrieved by the storage analysis module 1031 are corresponded to “confirming service resources,” “sending mail notice service resources,” “recommending service resources,” and “case management service resources,” respectively, and “confirming service resources,” “sending mail notice service resources,” “recommending service resources,” and “case management service resources” are the information technology resources 1200.

In an embodiment, besides the aforementioned search conditions, the storage searching module 1033 also can use “domain knowledge,” “graphs,” “relations,” and “execution levels” as the search conditions.

Next, step S207 is performed to link the first corresponding information technology resources with the first input commands by the resource linking module 1053 so as to correspond the first corresponding information technology resources to the process architecture.

For example, as shown in FIG. 2C, the resource linking module 1053 is configured to analyze and compare “informing teachers,” “confirming and filling in teacher information,” confirming and filling in time information,” “confirming and filling in location information,” “recommending members,” “sending invitations” and “issuing courses” (i.e. nodes 1116 to 1122) with “confirming service resources,” “sending mail notice service resources,” “recommending service resources,” and “case management service resources” of the information technology resources, and to correspond nodes 1116 to 1122 to “confirming service resources,” “sending mail notice service resources,” “recommending service resources,” and “case management service resources,” respectively.

As shown in FIG. 2C, nodes 1116 and 1121 are “informing teachers” and “sending invitations,” respectively, which are corresponding to “sending mail notice service resources.” Nodes 1117 to 1119 are “confirming and filling in teacher information,” “confirming and filling in time information,” and “confirming and filling in location information,” respectively, which are corresponding to “confirming service resources.” Node 1120 is “recommending members,” which is corresponding to “recommending service resources.” Node 1122 is “issuing courses,” which is corresponding to “case management service resources.”

In other words, the resource linking module 1053 enables the first corresponding information technology resources to correspond to nodes of the activities of the process architecture 1100, and enables the display 111 to display the corresponding relationships between the process architecture 1100 and the first corresponding information technology resources.

It should be appreciated that the reference letters A˜D shown in FIG. 2C are corresponding symbols which are merely used to illustrate an implementation of the present invention, and do not intend to limit the present invention. Moreover, the corresponding relationships between the process architecture 1100 and the first corresponding information technology resources may be illustrated in colors. Any method to enable the display to display the corresponding relationships between the process architecture and the first corresponding information technology resources should fall within the scope of the present invention.

In addition, besides by analyzing the corresponding relationships between the process architecture 1100 and the first corresponding information technology resources by the resource linking module 1053, a user may manually adjust the corresponding relationships between the process architecture 1100 and the first corresponding information technology resources by using the user interface module 101, so that the first corresponding information technology resources may satisfy the process architecture 1100 so as to obtain the optimum combination of the information technology resources.

After that, step S209 is performed to analyze the process architecture by the resource analysis module 1051 and to determine that at least one difference item is not linked with the first corresponding information technology resources.

For example, as shown in FIG. 2C, nodes 1111 and 1115 are “filling in course commencement information” and “selecting teachers,” respectively, and the corresponding symbols of nodes 1111 and 1115 are the reference letters X. The corresponding symbols X indicate that the process activities are partially or completely not satisfied by nodes 1111 and 1115. It means that both of nodes 1111 and 1115 are the difference items which are not linked with “confirming service resources,” “sending mail notice service resources,” “recommending service resources,” and “case management service resources” of the first corresponding information technology resources.

Furthermore, the resource linking module 1053 may enable display 111 to display the corresponding relationships between the process architecture 1100 and the first corresponding information technology resources. In other words, after the business process realization system 100 receives the first input commands, the business process realization system 100 enables the display 111 to automatically display the process architecture 1100, the first corresponding information technology resources, and the relationships between process architecture 1100 and the first corresponding information technology resources. It should be appreciated that the first corresponding information technology resources may be presented in a list, but the present invention is not limited thereto. Any method to present the relationships between the process architecture and the first corresponding information technology resources should fall within the scope of the present invention.

Next, step S211 is performed to receive a second input command corresponding to the at least one difference item by the user interface 101, to enable the resource adding module 1055 to add the at least one difference item to the first corresponding information technology resources according to the second command, and to enable the first corresponding information technology resources to be turned into the second corresponding information technology resources by the resource adding module 1055.

For example, the user may add the at least one difference item to the first corresponding information technology resources according to the relationships between the process architecture 1100 and the first corresponding information technology resources of step S209.

Specifically, as shown in FIG. 2D, the user may enter the second input command via the user interface module 101, such as “course service resources” and “teacher information service resources.” The resource adding module 1055 adds “course service resources” and “teacher information service resources” to the original first corresponding information technology resources according the second input command. After “course service resources” and “teacher information service resources” are added to the original first corresponding information technology resources, the first corresponding information technology resources turn into a plurality of second corresponding information technology resources, that is, the second corresponding information technology resources include “confirming service resources,” “sending mail notice service resources,” “recommending service resources,” “case management service resources,” “course service resources,” and “teacher information service resources.”

Then, step S213 is performed to link the second corresponding information technology resources with the process architecture 1100 by the resource linking module 1053 so as to correspond the second corresponding information technology resources to the process architecture 1100.

For example, as shown in FIG. 2E, by comparing the second corresponding information technology resources with the first corresponding information technology resources, the second corresponding information technology resources further include “course service resources” and “teacher information service resources.” In this embodiment, nodes 1111 and 1115 are “filling in course commencement information” and “selecting teachers,” respectively. The resource linking module 1053 corresponds “course service resources” to node 1111, and node 1111 is indicated by a corresponding symbol E. The resource linking module 1053 corresponds “teacher information service resources” to node 1115, and node 1115 is indicated by a corresponding symbol F.

Thereafter, step S215 is performed to store the second corresponding information technology resources into the storage unit 107 by the storage adding module 1035.

For example, referring to the following Table 1, Table 1 exhibits the relationships of between architecture and the information technology resources according to an embodiment of the present invention.

TABLE 1

| Process Activities | Information technology resources |
|---|---|
| Filling in course commencement | Course service resources |
| information (node 1111) | E |
| Selecting teachers | Teacher information service resources |
| (node 1115) | F |
| Informing teachers | Sending mail notice service resources |
| (node 1116) | B |
| Confirming and filling in teacher | Confirming service resources |
| information (node 1117) | A |
| Confirming and filling in time | Confirming service resources |
| information (node 1118) | A |
| Confirming and filling in location | Confirming service resources |
| information (node 1119) | A |
| Recommending members | Recommending service resources |
| (node 1120) | C |
| Sending invitations | Sending mail notice service resources |
| (node 1121) | B |
| Issuing courses | Case management service resources |
| (node 1122) | D |

As shown in Table 1, the storage adding module 1035 organizes and creates the relationships between all of the process activities and the information technology resources, and stores the relationships into the storage unit 107. Accordingly, the storage adding module 1035 further stores the corresponding relationships between the process architecture 1100 and the second corresponding information technology resources into the storage unit 107. Therefore, when the user interface module 101 receives the first input commands, the storage searching module 1033 retrieves the stored second corresponding information technology resources from the storage unit 107, and the stored second corresponding information technology resources correspond to the process architecture 1100. It should be appreciated that FIG. 2B to FIG. 2E are merely used to explain an implementation of the present invention, and do not intend to limit the present invention.

Furthermore, the aforementioned operation method 200 may be implemented by a non-transitory computer readable storage medium. The non-transitory computer readable storage medium stores a computer program, and the computer program may perform the operation method 200 when the computer program is loaded and executed. In this embodiment, the non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

As can be known from the above descriptions, by applying one of the above embodiments, the activities of the business process architecture are directly corresponding to the service resources of the information technology, and the business process architecture is linked to the information technology architecture. Accordingly, the implementations of the information technology resources will be no longer useless. When receiving similar commands, the business process realization system can quickly retrieve the corresponding information technology resources from the storage unit. Furthermore, the business process realization system further stores the corresponding relationships between the business process and the information technology resources. When one of the business process and the information technology resources needs to be adjusted, the user can still clearly understand the effects after adjustment. There is no need to check the entire system, and thus the time for checking the system, manpower and cost expenses can be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A business process realization system, comprising:
a storage unit configured to store a plurality of information technology resources;
a user interface module configured to receive a plurality of first input commands corresponding to a business process so that the business process is expanded into a process architecture according to the first input commands;
an access module, comprising:
a storage searching module configured to organize a plurality of search conditions according to the first input commands and the process architecture and to retrieve a plurality of search results from the information technology resources; and
a storage analysis module configured to analyze the search results and to retrieve a plurality of first corresponding information technology resources corresponding to the process architecture; and
an identification module, comprising:
a resource linking module configured to link the first corresponding information technology resources with the first input commands so as to correspond the first corresponding information technology resources to the process architecture; and
a resource analysis module configured to analyze the process architecture and to determine that at least one difference item is not linked with the first corresponding information technology resources.

2. The business process realization system of claim 1, wherein the identification module further comprises a resource adding module, and when the user interface module receives a second input command corresponding to the at least one different item, the resource adding module is configured to add the at least difference item to the first corresponding information technology resources according to the second command so as to turn the first corresponding information technology resources into the second corresponding information technology resources.

3. The business process realization system of claim 2, wherein the resource linking module further links the second corresponding information technology resources with the first input commands so as to correspond the second corresponding information technology resources to the process architecture.

4. The business process realization system of claim 3, wherein the access module further comprises a storage adding module configured to store the second corresponding information technology resources into the storage unit.

5. The business process realization system of claim 3, wherein the access module further comprises a storage adding module configured to store relationships between the process architecture and the second corresponding information technology resources into the storage unit.

6. The business process realization system of claim 1, further comprising an expansion module configured to expand the business process into the process architecture according to the first input commands and to enable a display to display the process architecture.

7. The business process realization system of claim 1, wherein the resource linking module further enables a display to display corresponding relationships between the process architecture and the first corresponding information technology resources.

8. The business process realization system of claim 6, wherein the process architecture comprises a tree architecture diagram or a fish-bone diagram.

9. An operation method for use in a business process realization system, the business process realization system comprising a storage unit, a user interface, an access module, and an identification module, the access module comprising a storage searching module and a storage analysis module, the identification module comprising a resource linking module and a resource analysis module, the operation method comprising:
receiving a plurality of first input commands corresponding to a business process by the user interface module, and expanding the business process into a process architecture according to the first input commands;
enabling the storage searching module to organize a plurality of search conditions according to the first input commands and the process architecture and retrieving a plurality of search results from a plurality of information technology resources;
analyzing the search results by the storage analysis module and retrieving a plurality of first corresponding information technology resources corresponding to the process architecture;
linking the first corresponding information technology resources with the first input commands by the resource linking module so as to correspond the first corresponding information technology resources to the process architecture; and
analyzing the process architecture by the resource analysis module and determining that at least one difference item is not linked with the first corresponding information technology resources.

10. The operation method of claim 9, wherein the identification module further comprises a resource adding module, the operation method further comprising:
receiving a second input command corresponding to the at least one difference item by the user interface;
enabling the resource adding module to add the at least difference item to the first corresponding information technology resources according to the second command; and
enabling the first corresponding information technology resources to be turned into the second corresponding information technology resources by the resource adding module.

11. The operation method of claim 10, further comprising:
linking the second corresponding information technology resources with the process architecture by the resource linking module so as to correspond the second corresponding information technology resources to the process architecture.

12. The operation method of claim 11, wherein the access module further comprises a storage adding module, the operation method further comprising:
storing the second corresponding information technology resources into the storage unit by the storage adding module.

13. The operation method of claim 9, wherein the business process realization system further comprises an expansion module, the operation method further comprising:
expanding the business process into the process architecture by the expansion module according to the first input commands and enabling a display to display the process architecture.

14. The operation method of claim 9, further comprising:
enabling a display to display corresponding relationships between the process architecture and the first corresponding information technology resources.

15. The operation method of claim 11, wherein the access module further comprises a storage adding module, the operation method further comprises:
storing relationships between the process architecture and the second corresponding information technology resources into the storage unit by the storage adding module.

16. A non-transitory computer readable storage medium having stored with a computer program executable to perform an operation method, in which the operation method is used in a business process realization system, the operation method comprising:
receiving a plurality of first input commands corresponding to a business process by the user interface module, and expanding the business process into a process architecture according to the first input commands;
enabling the storage searching module to organize a plurality of search conditions according to the first input commands and the process architecture and retrieving a plurality of search results from a plurality of information technology resources;
analyzing the search results by the storage analysis module and retrieving a plurality of first corresponding information technology resources corresponding to the process architecture;
linking the first corresponding information technology resources with the first input commands by the resource linking module so as to correspond the first corresponding information technology resources to the process architecture; and
analyzing the process architecture by the resource analysis module and determining that at least one difference item is not linked with the first corresponding information technology resources.
